(19) United States
(12) Patent Application Publication
(10) Pub. No.: US 2011/0220774 A1
(43) Pub. Date: Sep. 15, 2011

(54) Light Beam Detector

(75) Inventors: Theodore Bruce Ziemkowski, Windsor, CO (US); John Bonvallet, Boulder, CO (US)

(73) Assignee: Z-IMAGE, LLC, Windsor, CO (US)

(21) Appl. No.: 12/945,837

(22) Filed: Nov. 13, 2010

Related U.S. Application Data
(60) Provisional application No. 61/260,858, filed on Nov. 13, 2009.

(51) Int. Cl. H01J 40/12

(52) U.S. Cl. 250/200

(57) ABSTRACT

Light beam detection is used in a wide variety of applications, including manufacturing, security, transportation, scientific research, and amusement products. A system for detecting a moving light beam is comprised of a light beam detector, a moving light system, and a controller. A light beam detector may include a light receiver and a light sensor. A moving light system may include a focused light source and a light movement system. A controller may monitor the light detector for the presence or absence of a light beam and may control light beam movement and other aspects of the system.

### CROSS REFERENCE TO RELATED APPLICATIONS

This application claims benefit of and priority to U.S. Patent Application Ser. No. 61/260,858 filed 13 Nov. 2009 entitled “Method and Apparatus for Detection of a Moving Light Beam”, which is hereby expressly incorporated by reference for all it discloses and teaches.

### BACKGROUND

Light beam detection is used in a wide variety of applications, including manufacturing, security, transportation, scientific research, and amusement products. Typical examples include counting systems where objects pass through a light beam and are counted when the beam is broken, and laser maze amusement attractions where users are challenged to move through a space containing multiple laser beams without breaking any beams.

A typical light beam detection system involves a fixed light detector containing a photosensor such as a photodiode or CCD, a fixed light source such as a laser or focused LED, and an associated electronic controller that monitors the light detector and that may control the light source. Depending upon the application, light beam presence or absence events that are detected by the controller may be used to trigger further operations such as incrementing a counter, sounding an alarm, or turning equipment on or off.

In some applications, it may be desirable to use a moving light beam to cover more area than is possible with a single, fixed light source. The moving beam may be designed to scan back and forth over a line, or move in a more complex pattern over a two or even three dimensional surface. Detecting the presence and absence of a moving light beam can be difficult, because large arrays of traditional photosensors are both expensive and complex to design around. Synchronizing light detector movement with light beam movement may also be too complex and expensive for many applications.

### SUMMARY

A system for detecting a moving light beam has a light beam detector, a moving light system, and a controller. A light beam detector may include a light receiver and a light sensor. The light receiver may be constructed from multiple laminates of light transmissible material with grooves or other etchings placed along portions of the laminates. The moving light system may include a focused light source and a light movement system. A controller may monitor the beam detector for the presence or absence of a light beam and may control light beam movement and other aspects of the system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a schematic diagram illustration of an embodiment of a fixed light receiver designed to redirect light incident on the light receiver to a sensor.

FIG. 2 is a detailed schematic diagram illustration of an embodiment of the light pipe portion of the light receiver shown in FIG. 1.

FIG. 3 is a diagram illustration showing an embodiment of a light detector.

FIG. 4 is a diagram illustration showing an embodiment of a mechanism for generating a sweeping or moving laser beam.

### DETAILED DESCRIPTION

A moving light beam detection system has a light beam detector, a moving light source, and a controller. The light beam detector may be a multiple laminate detector that may detect the presence of a light beam that may be incident to any portion of the surface of the detector. The multiple laminates may serve as light pipes and may have patterns formed into the surface of the light pipes in specific areas and not in others. The laminates may be arranged such that at least one of the light pipes may have a pattern to capture light that may be incident to the detector. The light beam detector may have a sensor at one end that may receive light diffused through the patterns into the light pipes.

The light beam detector may include mirrors, diffusers, and other components in some embodiments.

A moving light system may include a laser, a stepper motor, and a mechanical transmission system including gears and cams. Other embodiments may use different light sources and different methods of moving the light source.

The controller for a moving light beam detection system may perform a variety of functions. In one embodiment, the controller is a computer with software that moves the light beam through a pre-determined pattern, analyzes the output of the light detector, performs computations to determine whether the light beam is present or absent on the detector surface, and provides various other output signals. Such embodiments may be useful in cases where the energy received by a sensor may vary with the location and direction of the light incident on the light beam detector.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

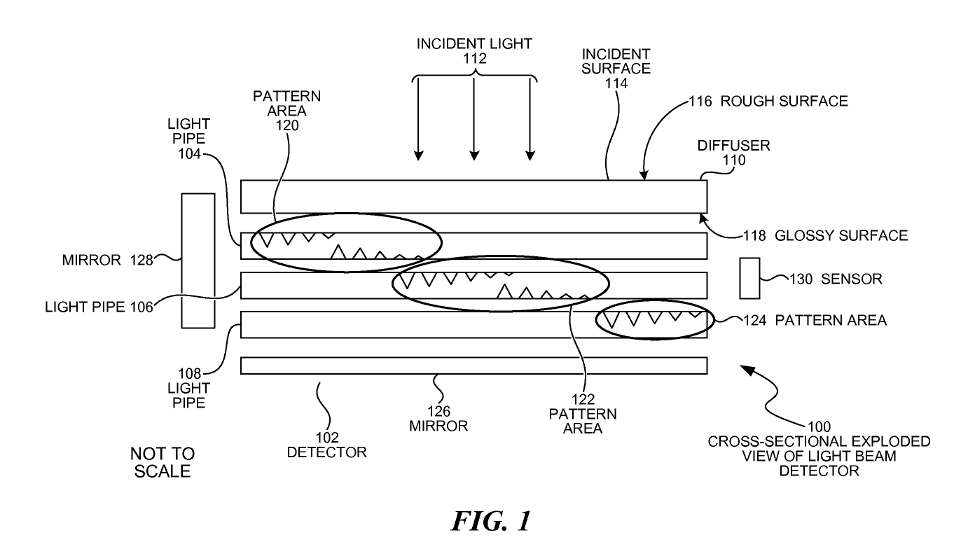

FIG. 1 is a cross-sectional exploded view of an embodiment 100 of a light receiver. Embodiment 100 is a schematic representation and is not to scale. Embodiment 100 shows a light beam detector that may have a sensor at one end, and may collect light from any point incident on the detector.

Embodiment 100 is an example of a sensor that may be used to detect a moving laser beam. The moving laser beam may scan across a large area of the light receiver, and the light receiver may capture the light and direct the light towards a sensor 130 located at the right hand side of the device.

In a typical use scenario, a laser beam may be mounted on a motorized mechanism that may sweep the laser beam back and forth. When the laser beam is incident to the detector 102 at any point along the surface of the detector, the sensor 130 may detect the light from the laser. The sensor 130 may be configured to detect only that the light is being received. In many embodiments, the sensor 130 may not be able to determine a position of the light, only that the light is either present or not.

In many cases, the signal received by the sensor 130 may vary to some extent based on the laser angle and position of the laser along the detector 102. The signal may be compared to some threshold value to determine whether a light is impinging on the detector 102.

The general arrangement of the detector 102 may be a planar laminate. Incident light 112 may impinge on the incident surface 114 and may be diffracted, reflected, dispersed, or otherwise caused to travel along the light pipes 104, 106, and 108 to the sensor 130. The sensor 130 may be oriented on a face of the light pipes that is perpendicular and adjacent to the incident surface 114. Other embodiments may have one, two, four, five, or more light pipes.

The detector 102 may contain multiple light pipes. In the example of embodiment 100, the detector 102 may have three light pipes 104, 106, and 108. Each of the light pipes may have pattern areas 120, 122, and 124, respectively.

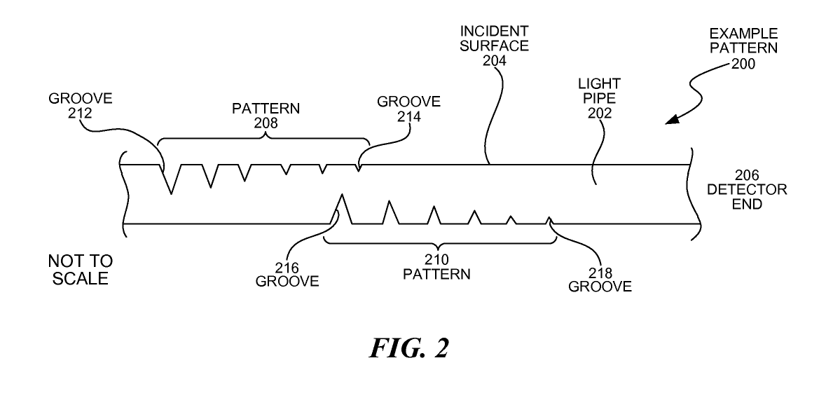

The pattern areas 120, 122, and 124 are areas of the light pipes that may collect and diffract light from the incident light 112 to be transmitted through the light pipes to the sensor 130. The pattern areas 120, 122, and 124 may be arranged in a staggered orientation such that incident light 112 may pass through one or more clear or non-patterned areas of the light pipe to impinge on the pattern areas. A close up example of the pattern areas may be described in FIG. 2, shown later in this specification.

The pattern areas may be designed to redirect light from impinging on the detector 102 at an angle up to normal to the incident surface 114, and redirect the light to be parallel with the long axis of the light pipes.

The light pipes may be any type of light transmissive material. In many embodiments, the light pipes may be formed from sheet polycarbonate, acrylic, or other plastic material.

Some embodiments may be predominately planar and may extend for several feet in length. A typical embodiment may be a several inches wide and an inch thick. Some embodiments may be larger or smaller depending on the application.

In some cases, the detector 102 may be curved. In such an embodiment, the detector 102 may be assembled as a flat assembly, then heated and bent to a desired shape. In another embodiment, each of the various components that make up the detector 102 may be formed into shape prior to assembly.

The detector 102 may be constructed by laminating various layers of the assembly together. In some embodiments, an adhesive may be used to join the various layers. In other embodiments, a heated bond may join the laminates. In some embodiments, the various layers may be mechanically clamped together without bonding the layers.

Some embodiments may have a diffuser 110 may have a rough surface 116 and a glossy surface 118. The diffuser 110 may serve to scatter incident light 112 within the detector 102. In some embodiments, the rough surface 116 of the diffuser 110 may be incorporated into the uppermost light pipe 104.

Some embodiments may have a mirror 126 that may be located at the far surface from the incident light 112. The mirror 126 may serve to increase the diffraction and reflections within the detector to increase the light signal detected by the sensor 130.

Some embodiments may have a mirror 128 that may be located at an end opposite the sensor 130 and tangential to the incident surface 114. The mirror 128 may serve to reflect light to the sensor 130 and thereby increase the signal received by the sensor 130.

In some embodiments, the mirrors 126 and 128 may be replaced by a diffractive white surface, such as a rough white surface. In some embodiments, the mirror 128 may be replaced with a second sensor.

The sensor element of the light detector may be comprised of one or more of a variety of photosensors, including CCDs or photodiodes. In some embodiments, multiple sensors may be used in conjunction with one another to improve light beam detection.

In environments where ambient light is high, it may be beneficial to place a narrow band light filter in front of the sensor. For example, if the moving light source output is centered about a wavelength of 500 nm, then a light filter centered near the same wavelength may filter out ambient light so that the sensor can effectively detect the moving light source.

FIG. 2 is a schematic illustration of an embodiment 200 showing a light pipe 202 in the pattern area. The light pipe 202 may have an incident surface 204 and a detector end 206. The detector end 206 may be the end to which a sensor may be mounted. Embodiment 200 is not to scale.

Embodiment 200 illustrates merely one example of a pattern that may be applied to a light pipe to deflect, diffract, reflect, disperse, or otherwise direct light from the incident surface 204 to the detector end 206. Other embodiments may use different patterns in different configurations.

The pattern 206 is shown on the top portion of the light pipe 202 and the pattern 208 is shown on the bottom portion of the light pipe 202. The orientation of the patterns is such that the patterns may overlap.

The patterns 206 and 208 may have a set of grooves that decrease in size as the patterns get closer to the detector end 206. The left hand grooves 212 and 216 are the deeper grooves while the right hand grooves 214 and 218 are the more shallow grooves.

The progressively shallower pattern of patterns 208 and 210 may allow light to enter the deeper portions of the grooves and be transmitted in the direction of the detector end 206 with at least a portion of the light not being impeded by other grooves in the pattern.

Other embodiments may use different patterns, either with or without the progressive nature of the patterns 208 and 210.

In some embodiments, the grooves may be evenly spaced. Other embodiments may space shallower grooves closer together than larger grooves.

In many embodiments, the patterns may be oriented perpendicular to the sensor located at the detector end 206. In some embodiments, the patterns may be straight across the width of a light pipe. In other embodiments, the patterns may be curved, with the center of the curve being approximately the position of a sensor when the light pipe 202 is assembled into a detector.

In embodiment 200, progressive grooves may be shown etched into both sides of each light pipe in an overlapping, step-wise fashion. The groove patterns may overlap slightly to allow for incident light to more likely strike a groove or other diffractive element. In other embodiments, deeper grooves might be etched into only one side of the light pipe.

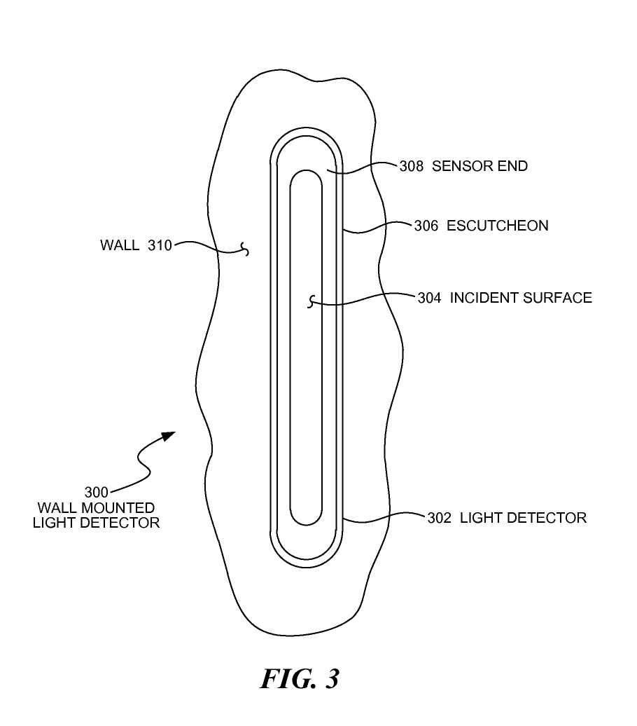

FIG. 3 shows a completed embodiment 300 of a scanning light detector, including a receiver and a sensor. Embodiment 300 shows a light detector 302 that may have an incident surface 304. An escutcheon 306 may be a trim piece that hides mounting hardware as the light detector 302 may be mounted on a wall 310. The light detector 302 may have a sensor end 308 at the top of the light detector 302.

The light detector 302 may be approximately 24 inches tall and 4 inches wide. Other embodiments may be larger or smaller, depending on the application.

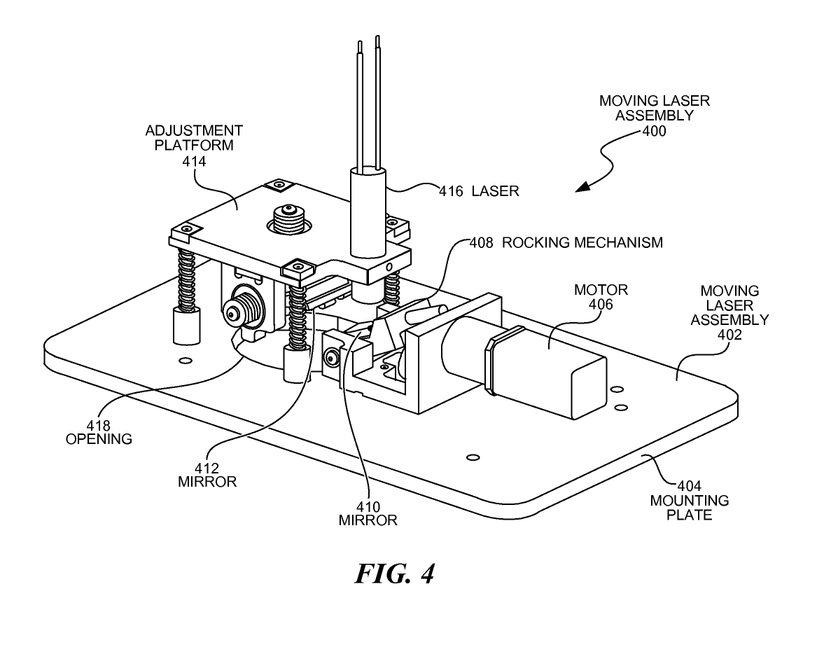

FIG. 4 is a diagram illustration of an embodiment 400 showing a moving laser assembly 402. The moving laser assembly 402 may have a mounting plate 404 that may serve to hold the various components as well as to mount the assembly in a wall or other location. A motor 406 may rotate, causing a rocking mechanism 408 to rock back and forth. The rocking mechanism 408 may have a mirror 410, that may oscillate.

A laser 416 may shine a beam to the mirror 410, which may reflect the beam to mirror 412 and out the opening 418. The mirror 412 may be mounted on an adjustment platform 414 that may allow a technician to fine tune the position of the laser beam when the beam is being projected.

Different light sources may be used in some embodiments, such as LEDs or light bulbs.

Some moving light source embodiments may use different movement systems. Other types of mechanical actuators can be used, such as servo motors, solenoids, or magnets. Gears and cams may be used in a variety of configurations with a variety of actuators to modulate movement. Some embodiments may employ electronic rather than mechanical means to move the light source, such as by using arrays of individual light sources.

A controller may perform several actions in a moving light beam detector system. The controller may move the light beam through a pre-determined pattern, control the light beam source, analyze the output of the light detector, perform computations to determine whether the light beam is present or absent on the light detector surface, and control other electronics.

The controller may control one or more moving light sources that produce a light beam. A light beam may be reflected by one or more reflectors, as illustrated in FIG. 4, and received by a light detector. The controller may be able to control light source movement, turn light sources on or off, and receive signals from light detectors.

The controller may change the movement of a light source in various manners. For example, the light movement pattern and speed may be changed progressively over time, or shifted at random.

In some embodiments, the controller may be able to cause the light source to pulsate, cause the light source to operate in sequence with other electronics, adjust light source intensity, or otherwise effect changes in the light source output.

The controller may be able to receive a signal from the light detector and thus determine whether the light beam is present or absent at the light detector. In some instances, the signal from the sensor may be an on/off or single bit digital signal, while in other instances the signal may be an analog or multi-bit digital signal that has multiple possible values.

When the controller may receive an analog or variable signal from the light detector, the controller may be able to process the signal to determine whether a light beam is present or absent at the detector. In some instances, the controller may receive input from more than one light detector sensor and may process the inputs either individually or together to detect the presence of a light beam.

The controller may use various other inputs, such as a reading from an ambient light sensor. For example, an ambient light reading could be used to help determine whether a light beam is present or absent at the light detector, or whether the ambient light level is too high for the system to function properly.

The controller may produce various outputs to control various devices. For example, if a moving light beam is blocked, other equipment may be turned on or off, or the intensity of the light beam may be adjusted.

In embodiments where the ambient light level is high compared to the light produced by the moving light source, the controller may attempt to filter out the ambient light signal by modulating the frequency of the moving light beam to one or more known frequencies and then monitoring for those frequencies at the light detector. For example, a laser modulated at 1 kHz or greater may be distinguished from ambient light.

In some embodiments, the controller may use light beam frequency modulation to encode multiple light sources with individual frequency signatures. The controller may then be able to distinguish which light sources are present and absent from a single light detector. This allows the use of multiple moving and fixed light sources with one light detector.

The foregoing description of the subject matter has been presented for purposes of illustration and description. It is not intended to be exhaustive or to limit the subject matter to the precise form disclosed, and other modifications and variations may be possible in light of the above teachings. The embodiments were chosen and described in order to best explain the principles of the invention and its practical application. This enables others skilled in the art to best utilize the invention in various embodiments and various modifications as are suited to the particular use contemplated. It is intended that the appended claims be construed to include other alternative embodiments except insofar as limited by the prior art.

What is claimed is:

1. A light sensor comprising:
a plurality of light pipes, each of said light pipes that have:
an incidence surface that receives light;
a detector end adjacent to said incidence surface;
a pattern formed into a portion of said incidence surface to create a patterned portion and a clear portion of said light pipe;
said plurality of light pipes being disposed such that said patterned portion of one of said light pipes is disposed adjacent to a clear portion of said light pipe;
a sensor disposed to sense light from said detector end.

2. The light sensor of claim 1, at least one of said light pipes comprising a second pattern on a surface opposite said incidence surface.

3. The light sensor of claim 1 further comprising:
a diffuser.

4. The light sensor of claim 3, said diffuser being located between said light and said incidence surface.

5. The light sensor of claim 4, said diffuser having a rough surface and a glossy surface.

6. The light sensor of claim 5, said glossy surface being disposed against said incidence surface of a top one of said light pipes.

7. The light sensor of claim 6 further comprising:
a mirror.

8. The light sensor of claim 7, said mirror being disposed opposite said incidence surface of one of said light pipes.

9. The light sensor of claim 7, said mirror being disposed opposite said detector end and adjacent to said incidence surface.

10. The light sensor of claim 1, said pattern comprising grooves.

11. The light sensor of claim 10, said grooves being disposed substantially perpendicular to said sensor.

12. The light sensor of claim 11, said grooves forming a straight line.

13. The light sensor of claim 11, said grooves forming a curved line having a center approximately at said sensor.

14. The light sensor of claim 10, said grooves comprising a set of grooves arranged from deepest to shallowest in a direction towards said sensor.

15. The light sensor of claim 14, said grooves being “V” shaped.

16. The light sensor of claim 15, said grooves being frosted.

17. The light sensor of claim 1, said patterned portion of a first light pipe overlapping said patterned portion of a second light pipe.

18. The light sensor of claim 1 further comprising:
a second sensor disposed on a second detector end opposite said detector end and adjacent to said incidence surface.
